(19) United States
(12) Patent Application Publication
(10) Pub. No.: US 2012/0056813 A1
(43) Pub. Date: Mar. 8, 2012

(54) SHAPE-CHANGEABLE CAMERA MOUSE

(75) Inventor: Yu-Yen Shih, Taipei (TW)

(73) Assignee: PRIMAX ELECTRONICS LTD., Taipei (TW)

(21) Appl. No.: 12/940,481

(22) Filed: Nov. 5, 2010

(30) Foreign Application Priority Data
Sep. 3, 2010 (TW) 099129826

(51) Int. Cl. G06F 3/033

(52) U.S. Cl. 345/166

(57) ABSTRACT

A shape-changeable camera mouse includes a first casing and a second casing. The first casing includes an image pickup module for shooting an object. When an included angle is defined between the first casing and the second casing, the shape-changeable camera mouse is operated in a mouse mode. Whereas, when the first casing and the second casing are parallel with each other, the shape-changeable camera mouse is operated in a camera mode.

### FIELD OF THE INVENTION

The present invention relates to an input device, and more particularly to an input device for use in a computer system.

### BACKGROUND OF THE INVENTION

The common input device of a computer system includes for example a mouse, a keyboard, a trackball or a touchpad. Among these input devices, the mouse is the most prevailing because it is very easy-to-use. When a mouse is held on the palm of a user's hand, the user may move the mouse to control movement of the cursor shown on the computer monitor.

FIG. 1 is a schematic diagram illustrating the connection between a conventional mouse and a computer system. As shown in FIG. 1, the computer system 2 comprises a computer host 21 and a computer monitor 22. The computer host 21 is in communication with a wheel mouse 1 and the computer monitor 22. A graphic-based window 221 and a cursor 222 are displayed on the computer monitor 22. The wheel mouse 1 is used for controlling the cursor 222 such that the computer host 21 executes a corresponding instruction. The wheel mouse 1 comprises a mouse body 10, a left button 11, a right button 12 and a scroll wheel 13. The mouse body 10 is used for supporting a user's palm. When the mouse body 10 is moved by the user to result in a displacement amount, the computer host 21 correspondingly moves the cursor 222 shown on the computer monitor 22 according to the displacement amount. By clicking the left button 11 or the right button 12, a control signal is issued to the computer host 21. In response to the control signal, the computer host 21 executes a corresponding instruction. By rotating the scroll wheel 13, the graphic-based window 221 shown on the computer monitor 21 may be scrolled upwardly or downwardly. The basic functions of the wheel mouse have been described above.

However, the mouse having the basic functions fails to meet the user's requirements. For complying with different conditions, a variety of mice with diverse functions have been introduced into the market. The mice with diverse functions include for example a wireless mouse with no physical connecting wire, a tilt wheel mouse having a function of horizontally moving the window, a motion sensitivity adjustable mouse, a slim mouse with a small volume, or a camera mouse having a function of shooting an object. Take a camera mouse for example. Hereinafter, a camera mouse will be illustrated with reference to FIGS. 2 and 3. FIG. 2 is a schematic perspective view illustrating the outward appearance of a conventional camera mouse. FIG. 3 is a schematic cross-sectional view illustrating the conventional camera mouse of FIG. 2. The conventional camera mouse 3 comprises a casing 30, a connecting wire 31, an optical displacement detecting module 32, a scroll wheel 33, an image pickup module 34 and shooting key 35. The casing 30 comprises a casing base 301. The displacement detecting module 32 and the image pickup module 34 are disposed on the casing base 301. The connecting wire 31 is connected with the computer system (not shown).

Please refer to FIG. 3. For operating the camera mouse 3, the camera mouse 3 is placed on a working surface D while the casing base 301 is contacted with the working surface D. The working surface D is for example a desk surface or a mouse pad. By rotating the scroll wheel 33, the graphic-based window of the computer system may be scrolled upwardly or downwardly. The optical displacement detecting module 32 is used for controlling the movement of the cursor of the computer system. The optical displacement detecting module 32 comprises a light emitting diode 321, a displacement lens 322 and a displacement sensing element 323. The displacement sensing element 323 is for example a charge coupled device (CCD). When the camera mouse 3 is placed on a working surface D to be operated, a light beam B emitted by the light emitting diode 321 is projected on the working surface D and reflected by the working surface D. The light beam B reflected by the working surface D penetrates through the displacement lens 322 and is focused onto the displacement sensing element 323. Consequently, a working surface image is acquired by the displacement sensing element 323. As the camera mouse 3 is continuously moved, plural working surface images are successively received by the displacement sensing element 323. According to the differences between the plural working surface images, a displacement data is acquired. According to the displacement data, the movement of the cursor is correspondingly controlled.

The image pickup module 34 comprises an image pickup lens set 341 and an image pickup sensing element 342. For example, the image pickup sensing element 342 is also a charge coupled device (CCD). When the user wants to use the image pickup module 34 of the camera mouse 3 to shoot an object, the image pickup module 34 is activated by pressing the shooting key 35. Meanwhile, the ambient light penetrates through the image pickup lens set 341 to be imaged on the image pickup sensing element 342. The acquired image is sent to the computer system through the connecting wire 31.

Although the conventional camera mouse has both the functions of a camera and a mouse, there are still some drawbacks. For example, since the shape of the camera mouse is similar to the common mouse, the camera mouse is not user-friendly when the camera mouse is used to shoot an object. Moreover, the camera mouse having the shape similar to the common mouse is not easily carried. In addition, the conventional camera mouse has no display screen for showing the acquired image. For viewing the image, the acquired image should be transmitted to the computer system and shown on the computer monitor.

Therefore, there is a need of providing an improved shape-changeable camera mouse so as to obviate the drawbacks encountered from the prior art.

### SUMMARY OF THE INVENTION

The present invention provides a shape-changeable camera mouse that is easily carried.

The present invention further provides a shape-changeable camera mouse having a camera-like appearance.

In accordance with an aspect of the present invention, there is provided a shape-changeable camera mouse. The shape-changeable camera mouse includes a first casing and a second casing. The first casing includes an optical displacement sensing element and an image pickup module. The image pickup module is disposed on a first lower surface of the first casing. The second casing is connected with the first casing. When the first lower surface of the first casing and a second lower surface of the second casing are parallel with each other, the shape-changeable camera mouse is operated in a camera mode. Whereas, when an included angle between the first lower surface of the first casing and the second lower surface of the second casing is smaller than 180 degrees, the shape-changeable camera mouse is operated in a mouse mode.

In an embodiment, the shape-changeable camera mouse further includes a connecting member for connecting the first casing and the second casing, so that the second casing is rotatable with respect to the first casing. The connecting member includes a first supporting frame, a second supporting frame, a first metallic gasket, a second metallic gasket and a rotating shaft. The first supporting frame is disposed at a rear side of the first casing, and has a first perforation. The second supporting frame is disposed at a front side of the second casing, and has a second perforation. The first metallic gasket has a first gasket hole. The second metallic gasket has a second gasket hole. The rotating shaft successively penetrates through the first metallic gasket, the first supporting frame, the second supporting frame and the second metallic gasket. The rotating shaft has a rotating shaft hole and a rotating shaft surface, and a notch is formed in the rotating shaft surface. Upon rotation of the rotating shaft surface, the notch is moved as the rotating shaft surface is rotated.

In an embodiment, the first casing further includes a resilient slice and a controlling unit. When the shape-changeable camera mouse is operated in the mouse mode, the resilient slice is inserted into the notch but not contacted with the rotating shaft surface. Whereas, when the shape-changeable camera mouse is operated in the camera mode, the notch is correspondingly moved and the resilient slice is contacted with the rotating shaft surface. The controlling unit is connected with the resilient slice for realizing whether the shape-changeable camera mouse is operated in the camera mode by judging whether the resilient slice is contacted with the rotating shaft surface.

In an embodiment, the controlling unit is a microprocessor.

In an embodiment, the shape-changeable camera mouse further includes a signal wire penetrating through the rotating shaft hole for establishing electrical connection between the first casing and the second casing.

In an embodiment, the first casing further includes a first slant surface at a rear side of the first casing, and the second casing further includes a second slant surface at a front side of the second casing. When a first slant upper rim of the first slant surface is contacted with a second slant lower rim of the second slant surface, the first lower surface of the first casing is parallel with the second lower surface of the second casing and the shape-changeable camera mouse is operated in the camera mode. Whereas, when the first slant upper rim of the first slant surface is contacted with a second slant upper rim of the second slant surface, the included angle smaller than 180 degrees is defined between the first lower surface of the first casing and the second lower surface of the second casing and the shape-changeable camera mouse is operated in the mouse mode.

In an embodiment, the second casing includes a battery and a display screen. The battery is disposed within the second casing for providing electricity. The display screen is disposed on the second lower surface of the second casing for showing an image that is acquired by the image pickup module.

In an embodiment, the first casing further includes a first button, a second button, an optical finger navigation sensor and a circuit board. The first button is disposed on a first upper surface of the first casing. The second button is disposed on the first upper surface, and arranged beside the first button. The optical finger navigation sensor is exposed to the first upper surface and arranged between the first button and the second button for providing a function of scrolling a graphic-based window. The circuit board is disposed within the first casing. The optical displacement sensing element, the image pickup module and the optical finger navigation sensor are mounted on the circuit board.

In an embodiment, when the first lower surface of the first casing is parallel with the second lower surface of the second casing, the shape-changeable camera mouse has a rectangular shape.

In an embodiment, the shape-changeable camera mouse further includes a wireless emitter and a wireless receiver. The wireless emitter is disposed within the first casing for generating a wireless signal. The wireless receiver is connected with a computer system for receiving the wireless signal, thereby controlling a cursor of the computer system.

The above objects and advantages of the present invention will become more readily apparent to those ordinarily skilled in the art after reviewing the following detailed description and accompanying drawings, in which:

### BRIEF DESCRIPTION OF THE DRAWINGS

FIG. 1 is a schematic diagram illustrating the connection between a conventional mouse and a computer system;

FIG. 2 is a schematic perspective view illustrating the outward appearance of a conventional camera mouse;

FIG. 3 is a schematic cross-sectional view illustrating the conventional camera mouse of FIG. 2;

FIG. 4 is a schematic diagram illustrating the connection between a shape-changeable camera mouse and a computer system according to an embodiment of the present invention;

FIG. 5 is a schematic partial exploded view illustrating the shape-changeable camera mouse according to the embodiment of the present invention;

FIG. 6 is a schematic perspective view illustrating the internal portion of the shape-changeable camera mouse in a mouse mode according to an embodiment of the present invention;

FIG. 7 is a schematic perspective view illustrating the external appearance of the shape-changeable camera mouse of FIG. 6;

FIG. 8 is a schematic perspective view illustrating the external appearance of the shape-changeable camera mouse in a camera mode according to an embodiment of the present invention; and

FIG. 9 is a schematic perspective view illustrating the internal portion of the shape-changeable camera mouse of FIG. 8.

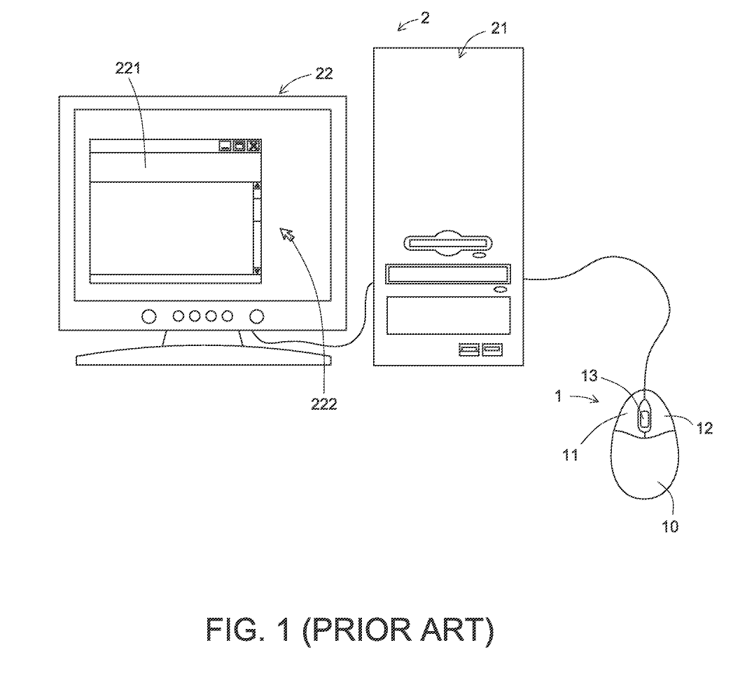

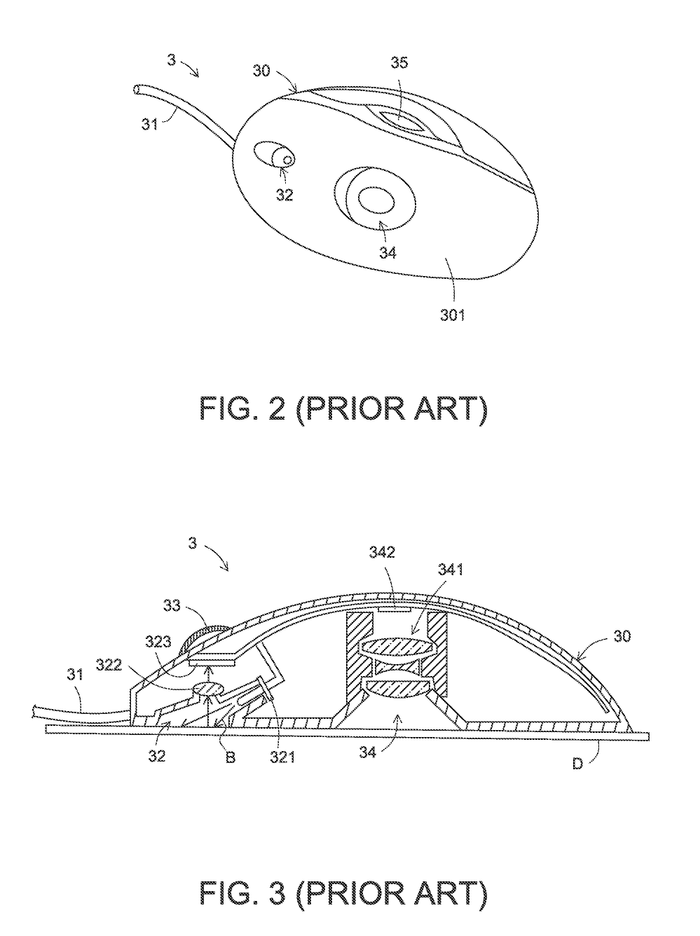

### DETAILED DESCRIPTION OF THE PREFERRED EMBODIMENT

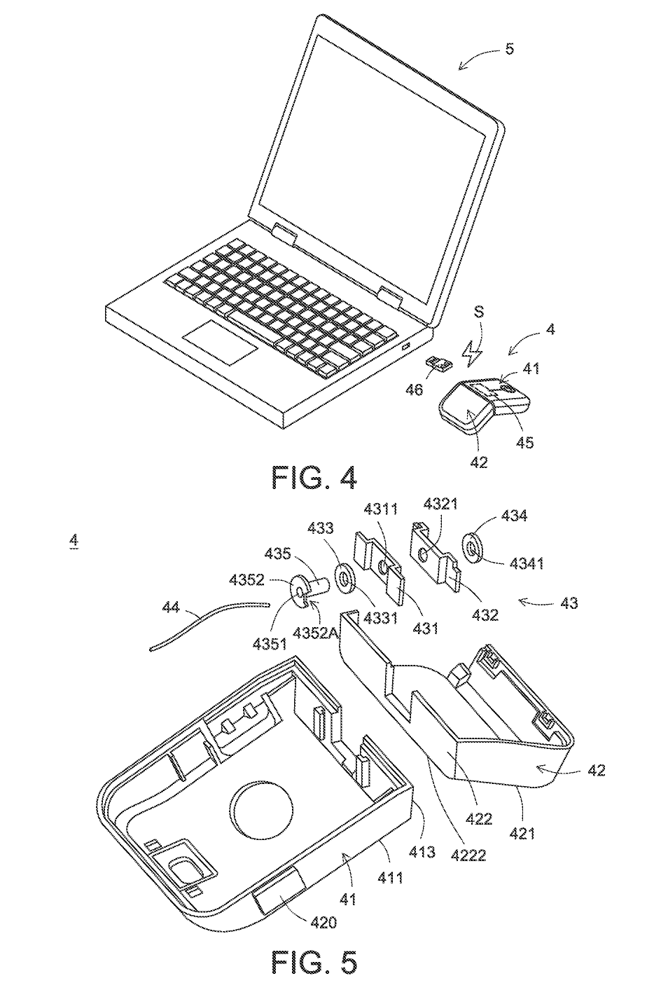

For obviating the drawbacks encountered from the prior art, the present invention provides a shape-changeable camera mouse. FIG. 4 is a schematic diagram illustrating the connection between a shape-changeable camera mouse and a computer system according to an embodiment of the present invention. As shown in FIG. 4, the shape-changeable camera mouse 4 comprises a first casing 41, a second casing 42, a wireless emitter 45 and a wireless receiver 46. The wireless emitter 45 is disposed within the first casing 41 for generating a wireless signal S. The wireless receiver 46 is connected with a computer system 5 for receiving the wireless signal S. In this embodiment, the computer system 5 is a notebook computer.

Hereinafter, the configurations of the shape-changeable camera mouse will be illustrated with reference to FIG. 5. FIG. 5 is a schematic partial exploded view illustrating the shape-changeable camera mouse according to the embodiment of the present invention. In addition to the first casing 41 and the second casing 42, the shape-changeable camera mouse 4 further comprises a connecting member 43 and a signal wire 44. The first casing 41 comprises a first lower surface 411, a first upper surface 412 (see FIG. 7) and a first slant surface 413. The first slant surface 413 is arranged at a rear side of the first casing 41. In addition, the first slant surface 413 has a first slant upper rim 4131 (see FIG. 7). The second casing 42 comprises a second lower surface 421 and a second slant surface 422. The second slant surface 422 is arranged at a front side of the second casing 42. In addition, the second slant surface 422 has a second slant upper rim 4221 (see FIG. 7) and a second slant lower rim 4222.

The connecting member 43 comprises a first supporting frame 431, a second supporting frame 432, a first metallic gasket 433, a second metallic gasket 434 and a rotating shaft 435. The first supporting frame 431 is disposed at the rear side of the first casing 41. In addition, the first supporting frame 431 has a first perforation 4311. The second supporting frame 432 is disposed at the front side of the second casing 42. In addition, the second supporting frame 432 has a second perforation 4321. The first metallic gasket 433 has a first gasket hole 4331. The second metallic gasket 434 has a second gasket hole 4341. The rotating shaft 435 successively penetrates through the first metallic gasket 433, the first supporting frame 431, the second supporting frame 432 and the second metallic gasket 434. The rotating shaft 435 has a rotating shaft hole 4351 and a rotating shaft surface 4352. In addition, a notch 4352A is formed in the rotating shaft surface 4352. Upon rotation of the rotating shaft surface 4352, the notch 4352A is moved as the rotating shaft surface 4352 is rotated. The signal wire 44 penetrates through the rotating shaft hole 4351 for establishing electrical connection between the first casing 41 and the second casing 42. That is, since the first casing 41 and the second casing 42 are connected with each other through the connecting member 43, the second casing 42 can be rotated with respect to the first casing 41 to change the shape of the shape-changeable camera mouse 4.

In accordance with a key feature of the present invention, the shape-changeable camera mouse 4 may be switched between a mouse mode and a camera mode by changing the shape of the shape-changeable camera mouse 4.

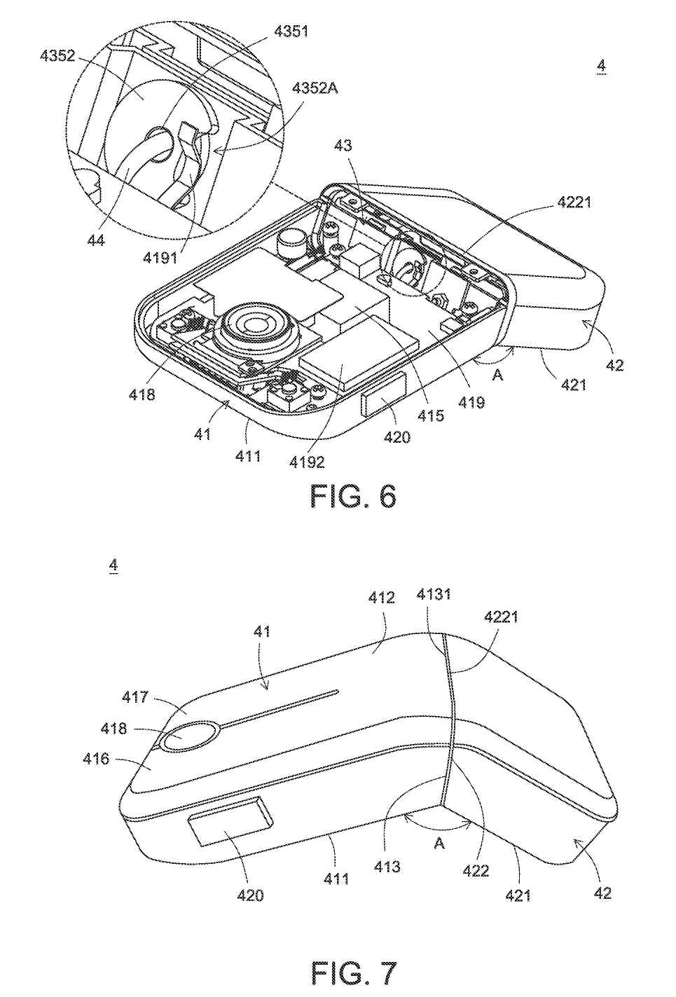

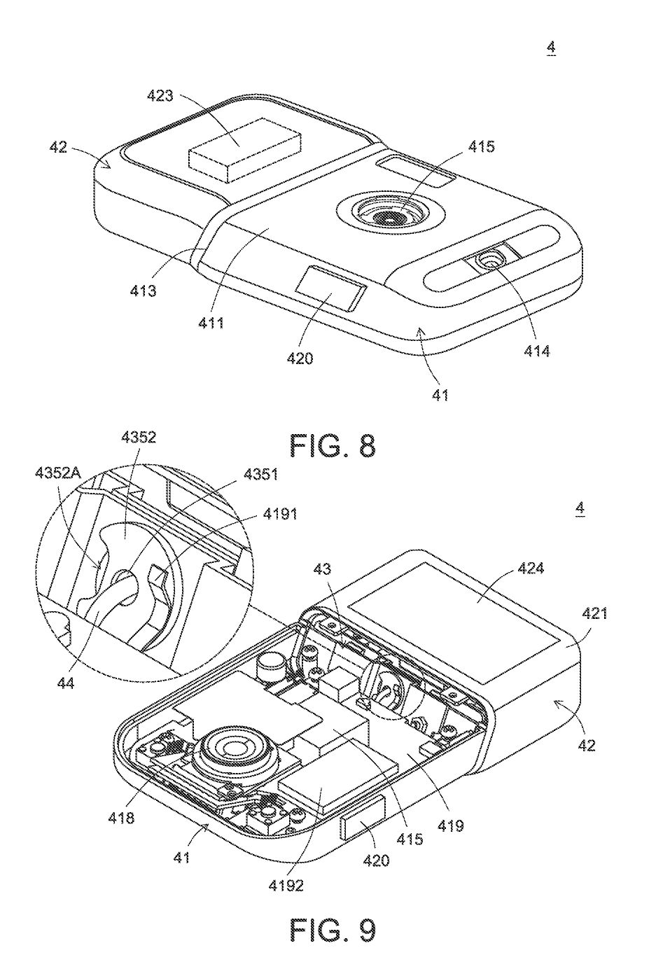

FIG. 6 is a schematic perspective view illustrating the internal portion of the shape-changeable camera mouse in a mouse mode according to an embodiment of the present invention. FIG. 7 is a schematic perspective view illustrating the external appearance of the shape-changeable camera mouse of FIG. 6. Please refer to FIGS. 6 and 7. In addition to the casing surface, the first casing 41 of the shape-changeable camera mouse 4 further comprises an optical displacement sensing element 414 (see FIG. 8), an image pickup module 415, a first button 416, a second button 417, an optical finger navigation (OFN) sensor 418, a circuit board 419 and a shooting key 420. According to the movement of the shape-changeable camera mouse 4 on a working surface, the optical displacement sensing element 414 generates a corresponding displacement amount. The image pickup module 415 is used for shooting an object to acquire an image. The first button 416 is disposed on the first upper surface 412 of the first casing 41. The second button 417 is disposed on the first upper surface 412, and arranged beside the first button 416. In this embodiment, the first button is a left button, and the second button 417 is a right button. The optical finger navigation sensor 418 is disposed on the circuit board 419, exposed to the first upper surface 412, and arranged between the first button 416 and the second button 417. The use of the optical finger navigation sensor 418 may provide a function of scrolling a graphic-based window shown on the computer monitor.

Please refer to FIGS. 6 and 7 again. The circuit board 419 is disposed within the first casing 41. The optical displacement sensing element 414, the image pickup module 415 and the optical finger navigation sensor 418 are mounted on the circuit board 419. The signal wire 44 penetrates through the rotating shaft hole 4351 to be electrically connected with the circuit board 419. In addition, a resilient slice 4191 and a controlling unit 4192 are also disposed on the circuit board 419. In a case that the shape-changeable camera mouse 4 is operated in the mouse mode, the resilient slice 4191 is inserted into the notch 4352A but not contacted with the rotating shaft surface 4352. Whereas, in a case that the shape-changeable camera mouse 4 is operated in a camera mode, the notch 4352A is correspondingly moved and thus the resilient slice 4191 is contacted with the rotating shaft surface 4352. The controlling unit 4192 is connected with the resilient slice 4191 through the circuit board 419. By judging whether the resilient slice 4191 is contacted with the rotating shaft surface 4352 or not, the controlling unit 4192 may realize that the shape-changeable camera mouse 4 is operated in either the camera mode or the mouse mode. An example of the controlling unit 4192 is a microprocessor.

In a case that the shape-changeable camera mouse 4 is operated in the mouse mode by rotating the second casing 42 with respect to the first casing 41, the first slant upper rim 4131 of the first slant surface 413 is contacted with the second slant upper rim 4221 of the second slant surface 422. Meanwhile, there is an included angle A between the first lower surface 411 of the first casing 41 and the second lower surface 421 of the second casing 42. The included angle A is smaller than 180 degrees. In particular, the included angle A is an obtuse angle. Meanwhile, a cambered surface is defined between the first casing 41 and the second casing 42 for supporting the user's palm (see FIG. 6).

By the way, when the shape-changeable camera mouse 4 is operated in the mouse mode, the resilient slice 4191 is inserted into the notch 4352A but not contacted with the rotating shaft surface 4352 (see FIG. 7). Consequently, the voltage transmitted from the resilient slice 4191 is a high logic level voltage. In response to the high logic level voltage, the controlling unit 4192 judges that the shape-changeable camera mouse 4 is operated in the mouse mode.

FIG. 8 is a schematic perspective view illustrating the external appearance of the shape-changeable camera mouse in a camera mode according to an embodiment of the present invention. FIG. 9 is a schematic perspective view illustrating the internal portion of the shape-changeable camera mouse of FIG. 8. Please refer to FIGS. 8 and 9. In a case that the shape-changeable camera mouse 4 is operated in the camera mode by rotating the second casing 42 with respect to the first casing 41, the first slant upper rim 4131 of the first slant surface 413 is contacted with the second slant lower rim 4222 of the second slant surface 422. Meanwhile, the first lower surface 411 of the first casing 41 and the second lower surface 421 of the second casing 42 are parallel with each other. In this situation, the shape-changeable camera mouse has a rectangular shape (see FIG. 8). In addition, upon synchronous of the rotating shaft 435 with the second casing 42, the notch 4352A is moved as the rotating shaft surface 4352 is rotated. Consequently, the resilient slice 4191 is contacted with the rotating shaft surface 4352. In this situation, the voltage transmitted from the resilient slice 4191 is switched from the high logic level voltage to a ground voltage. In response to the ground voltage, the controlling unit 4192 judges that the shape-changeable camera mouse 4 is operated in the camera mode.

Please refer to FIGS. 8 and 9 again. The second casing 42 further comprises a battery 423 and a display screen 424. The battery 423 is disposed within the second casing 42 for providing electricity. The display screen 424 is disposed on the second lower surface 421 of the second casing 42 for showing the image acquired by the image pickup module 415. By pressing the shooting key 420 of the first casing 41, the image pickup module 415 is triggered to shoot the object. It is noted that the image acquired by the image pickup module 415 is transmitted from the first casing 41 to the display screen 424 of the second casing 42 through the signal wire 44. Similarly, electricity may be transmitted from the battery 423 of the second casing 42 to the circuit board 419 of the first casing 41 through the signal wire 44. As a consequence, the electricity required for operating the shape-changeable camera mouse 4 is acquired by the circuit board 419.

From the above description, the shape of the shape-changeable camera mouse of the present invention may be adjusted according to the practical requirements of the user. For using the shape-changeable camera mouse in a computer system, the shape-changeable camera mouse is operated in a mouse mode by changing the shape thereof. For using the shape-changeable camera mouse to shoot an object, the shape-changeable camera mouse is operated in a camera mode by changing the shape thereof. When the shape-changeable camera mouse is operated in the camera mode, the shape-changeable camera mouse may be used to shoot an object to acquire an image, and the acquired image may be shown on the display screen. In addition, when the shape-changeable camera mouse of the present invention is operated in the camera mode, the shape-changeable camera mouse has a flat rectangular shape similar to the common camera. Since the shape-changeable camera mouse having the flat rectangular shape may be placed in the coat pocket or the trouser pocket of the user, the shape-changeable camera mouse is easily carried.

While the invention has been described in terms of what is presently considered to be the most practical and preferred embodiments, it is to be understood that the invention needs not be limited to the disclosed embodiment. On the contrary, it is intended to cover various modifications and similar arrangements included within the spirit and scope of the appended claims which are to be accorded with the broadest interpretation so as to encompass all such modifications and similar structures.

What is claimed is:

1. A shape-changeable camera mouse, comprising:
a first casing comprising an optical displacement sensing element and an image pickup module, wherein said image pickup module is disposed on a first lower surface of said first casing; and
a second casing connected with said first casing, wherein when said first lower surface of said first casing and a second lower surface of said second casing are parallel with each other, said shape-changeable camera mouse is operated in a camera mode, wherein when an included angle between said first lower surface of said first casing and said second lower surface of said second casing is smaller than 180 degrees, said shape-changeable camera mouse is operated in a mouse mode.

2. The shape-changeable camera mouse according to claim 1 further comprising a connecting member for connecting said first casing and said second casing, so that said second casing is rotatable with respect to said first casing, wherein said connecting member comprises:
a first supporting frame disposed at a rear side of said first casing, and having a first perforation;
a second supporting frame disposed at a front side of said second casing, and having a second perforation;
a first metallic gasket having a first gasket hole;
a second metallic gasket having a second gasket hole; and
a rotating shaft successively penetrating through said first metallic gasket, said first supporting frame, said second supporting frame and said second metallic gasket, wherein said rotating shaft has a rotating shaft hole and a rotating shaft surface, and a notch is formed in said rotating shaft surface, wherein upon rotation of said rotating shaft surface, said notch is moved as said rotating shaft surface is rotated.

3. The shape-changeable camera mouse according to claim 2 wherein said first casing further comprises:
a resilient slice, wherein when said shape-changeable camera mouse is operated in said mouse mode, said resilient slice is inserted into said notch but not contacted with said rotating shaft surface, wherein when said shape-changeable camera mouse is operated in said camera mode, said notch is correspondingly moved and said resilient slice is contacted with said rotating shaft surface; and
a controlling unit connected with said resilient slice for realizing whether said shape-changeable camera mouse is operated in said camera mode by judging whether said resilient slice is contacted with said rotating shaft surface.

4. The shape-changeable camera mouse according to claim 3 wherein said controlling unit is a microprocessor.

5. The shape-changeable camera mouse according to claim 2 further comprising a signal wire penetrating through said rotating shaft hole for establishing electrical connection between said first casing and said second casing.

6. The shape-changeable camera mouse according to claim 1 wherein said first casing further comprises a first slant surface at a rear side of the first casing, and said second casing further comprises a second slant surface at a front side of said second casing, wherein when a first slant upper rim of said first slant surface is contacted with a second slant lower rim of said second slant surface, said first lower surface of said first casing is parallel with said second lower surface of said second casing and said shape-changeable camera mouse is operated in said camera mode, wherein when said first slant upper rim of said first slant surface is contacted with a second slant upper rim of said second slant surface, said included angle smaller than 180 degrees is defined between said first lower surface of said first casing and said second lower surface of said second casing and said shape-changeable camera mouse is operated in said mouse mode.

7. The shape-changeable camera mouse according to claim 1 wherein said second casing comprises:
a battery disposed within said second casing for providing electricity; and
a display screen disposed on said second lower surface of said second casing for showing an image that is acquired by said image pickup module.

8. The shape-changeable camera mouse according to claim 1 wherein said first casing further comprises:
a first button disposed on a first upper surface of said first casing;
a second button disposed on said first upper surface, and arranged beside said first button;
an optical finger navigation sensor exposed to said first upper surface and arranged between said first button and said second button for providing a function of scrolling a graphic-based window; and
a circuit board disposed within said first casing, wherein said optical displacement sensing element, said image pickup module and said optical finger navigation sensor are mounted on said circuit board.

9. The shape-changeable camera mouse according to claim 1 wherein when said first lower surface of said first casing is parallel with said second lower surface of said second casing, said shape-changeable camera mouse has a rectangular shape.

10. The shape-changeable camera mouse according to claim 1 further comprising a wireless emitter and a wireless receiver, wherein said wireless emitter is disposed within said first casing for generating a wireless signal, and said wireless receiver is connected with a computer system for receiving the wireless signal, thereby controlling a cursor of said computer system.
